(19) United States
(12) Patent Application Publication
(10) Pub. No.: US 2026/0143566 A1
(43) Pub. Date: May 21, 2026

(54) METAL PIPE HEATING APPARATUSES AND ASSOCIATED SYSTEMS AND METHODS

(71) Applicant: Jimmie Ray Gatlin, Port Neches, TX (US)

(72) Inventor: Jimmie Ray Gatlin, Port Neches, TX (US)

(21) Appl. No.: 19/063,082

(22) Filed: Feb. 25, 2025

Related U.S. Application Data
(60) Provisional application No. 63/721,264, filed on Nov. 15, 2024.

(51) Int. Cl. H05B 3/34

(52) U.S. Cl. CPC H05B 3/34

(57) ABSTRACT

Metal pipe heating apparatuses and associated systems and methods are disclosed. For example, a heating apparatus comprises a flexible sheath configured to hold one or more heat sources within a lumen of the sheath. The flexible sheath includes one or more magnetic elements coupled to the flexible sheath. The flexible sheath is configured to couple to a portion of a pipe and/or pipe system via the magnetic force of the magnetic elements. Once the flexible sheath is adhered to the portion of the pipe via the magnetic elements, heat sources contained within the flexible sheath can apply heat to the portion of the pipe, increasing the temperature of the pipe, piping system, and/or substance transported by the pipe/piping system.

### CROSS-REFERENCE TO RELATED APPLICATION(S)

This application claims priority to U.S. Provisional Ser. No. 63/721,264, titled “METAL PIPE HEATING APPARATUSES AND ASSOCIATED SYSTEMS AND METHODS,” and filed Nov. 15, 2024, which is incorporated by reference herein in its entirety.

### TECHNICAL FIELD

The present disclosure is generally related to devices for heating pipes and piping systems.

### BACKGROUND

Pipes and piping systems lose heat when their temperature is greater than ambient temperature. If the temperature gets too low, the substances being transported by the piping system (e.g., fluids, gases, etc.) may solidify, become overly viscous, or exhibit other undesirable properties. Furthermore, many components of piping systems may become damaged or fail if their temperature drops too far. One process of mitigating and/or preventing heat loss of piping systems involves heat tracing. Heat tracing generally involves running a heating element along a portion of the pipe/piping system and using the heat of the heating element to maintain and/or raise the temperature of the system. However, challenges arise when trying to run heating elements along certain complicated and/or difficult-to-access piping arrangements. Furthermore, ensuring adequate coupling and/or contact between the heating element and the pipe/piping system can be difficult, time consuming, and expensive.

### BRIEF DESCRIPTION OF THE DRAWINGS

FIG. 1A is a perspective view of an apparatus configured in accordance with some embodiments of the present technology.

FIG. 1B is a perspective view of an apparatus configured in accordance with some embodiments of the present technology.

FIG. 2A is a perspective view of a system configured in accordance with some embodiments of the present technology.

FIG. 2B is a perspective view of a system configured in accordance with some embodiments of the present technology.

FIG. 3 is a perspective view of an apparatus configured in accordance with some embodiments of the present technology.

FIGS. 4A-4F are various schematic cross-sectional views of an apparatus configured in accordance with some embodiments of the present technology.

FIG. 5 is a flow chart illustrating a method in accordance with some embodiments of the present technology.

The drawings have not necessarily been drawn to scale. Similarly, some components and/or operations may be separated into different blocks or combined into a single block for the purposes of discussion of some of the embodiments of the disclosed system. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents and alternatives falling within the scope of the technology as defined by the appended examples.

### DETAILED DESCRIPTION

The present technology is directed to metal pipe heating apparatuses and associated systems and methods. For example, some methods of heating a pipe may involve coupling an electric heating element to a length of pipe and/or a section of a piping system, and using the heat produced by the electric heating element to apply heat to the associated pipe/piping system (often referred to as heat tracing). Usually, the heating element is coupled to the pipe via strapping, tape, wiring, and the like. However, these coupling mechanisms can be cumbersome, expensive, result in insufficient adherence between the pipe and the heating element.

The present technology addresses these and other issues by providing a heating apparatus comprising a flexible sheath (i.e., a tube, a hollow cylinder, etc.) configured to hold one or more heat sources (e.g., electric heating elements, high-temperature fluid, high-temperature gas, and the like) within a lumen of the sheath. The flexible sheath includes one or more magnetic elements (e.g., puck-shaped magnets, square or rectangular magnets, magnetic tape, magnetic shroud material, a magnetic liner, and the like) coupled to the flexible sheath. The flexible sheath is configured to couple to a portion of a pipe (e.g., a ferrous surface) and/or pipe system via the magnetic force of the magnetic elements. Once the flexible sheath is adhered to the portion of the pipe via the magnetic elements, heat sources contained within the flexible sheath apply heat to the portion of the pipe, increasing the temperature of the pipe, piping system, and/or substance transported by the pipe/piping system. In some embodiments, the heating apparatus includes one or more temperature sensing elements (e.g., thermistors) configured to provide temperature information to a controller (e.g., through a wired or wireless connection). The controller is configured to control the amount of heat applied to the portion of the pipe by controlling the temperature of the heat source and/or the heat generated by the heat source.

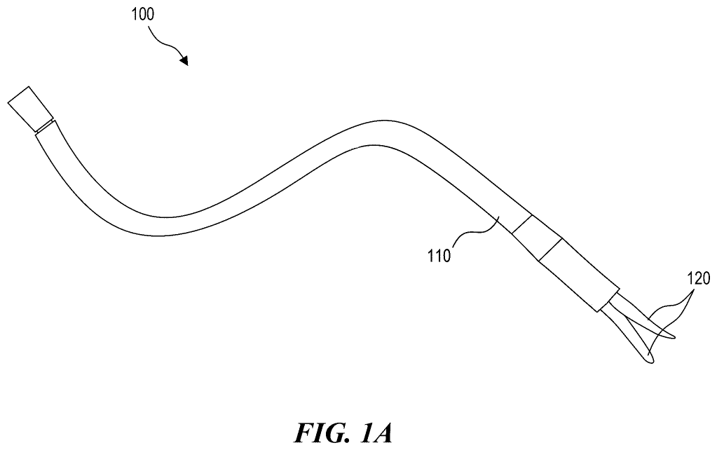

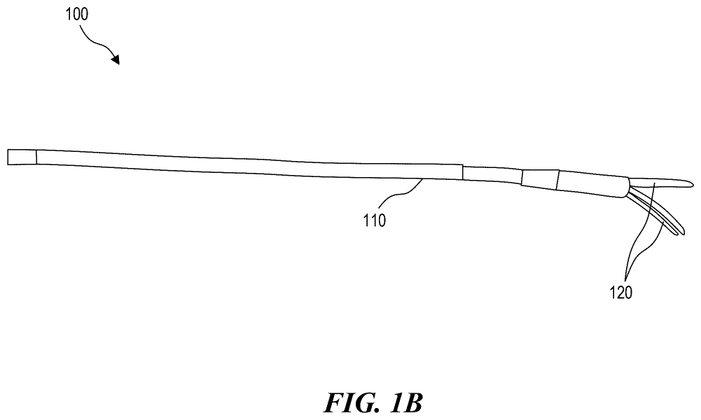

FIGS. 1A and 1B are perspective views of an apparatus 100 configured in accordance with some embodiments of the present technology. Referring to FIGS. 1A and 1B together, in the present embodiments, apparatus 100 is comprised of a flexible sheath 110 configured to hold (i.e., encase, enshroud, contain, etc.) one or more heat sources 120. In some embodiments, such as those shown in FIGS. 1A and 1B, the heat sources 120 are electric heating elements configured to generate heat when a current is passed through the heating elements. In some embodiments, the heat sources 120 can include a fluid and/or gas configured to transfer heat to the surrounding sheath 110 (e.g., via conduction and/or convection), and subsequently a pipe or piping system and/or fluid/gas being transported therein. In some embodiments, the flexible sheath 110 is comprised of a plurality of interlocking metal segments. In the present embodiments, apparatus 100 can be configured to have multiple bends and/or curves at various positions along the length of the apparatus 100 (as shown in FIG. 1A), and can be configured to have a generally straight (i.e., unbent, uncurved) configuration (as shown in FIG. 1B).

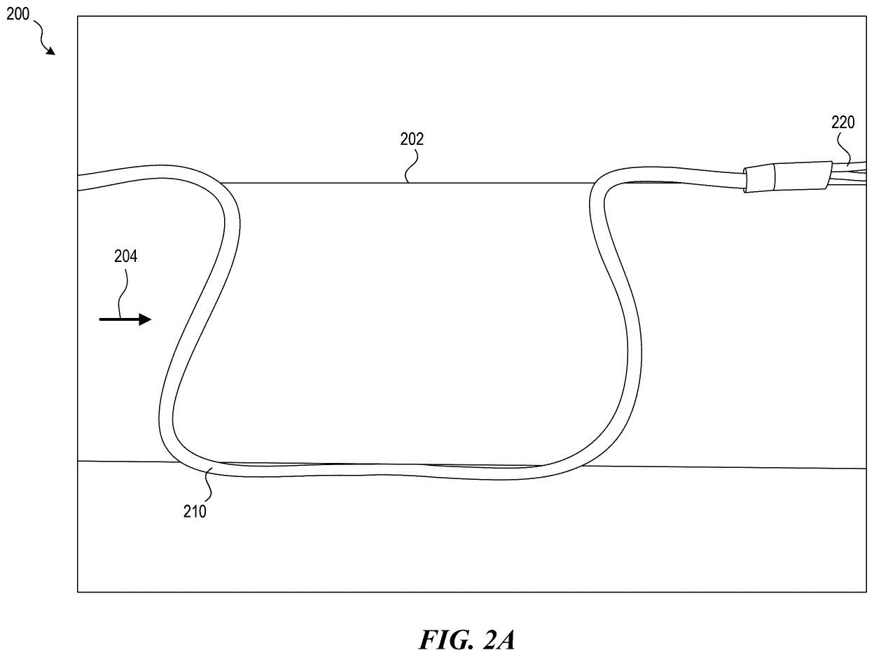

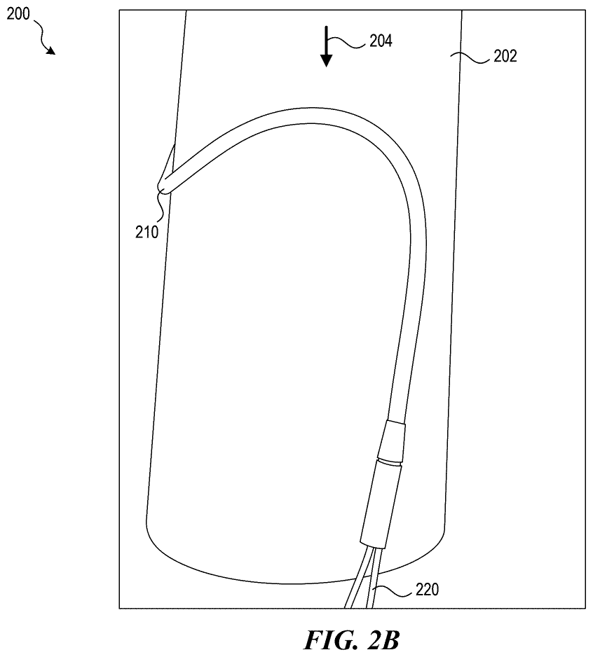

FIGS. 2A and 2B are perspective views of a system 200 configured in accordance with some embodiments of the present technology. In some embodiments, FIGS. 2A and 2B include features and components generally similar/identical to features and components of the apparatus 100 of FIGS. 1A and 1B. Referring to FIGS. 2A and 2B together, in the present embodiments, system 200 is comprised of a flexible sheath 210 configured to couple to a pipe 202. The flexible sheath 210 is configured to hold one or more heat sources 220. The pipe 202 is configured to transport a substance 204 (e.g., a fluid, a gas, and the like). The heat sources 220 are configured to generate (e.g., in the case of an electric heating element) and/or transfer heat, which can be transferred (e.g., via conduction and/or convection) to portions and/or sections of the pipe 202 (and a piping system including the pipe 202) in contact with the flexible sheath 210. The heat transferred to the pipe 202 can subsequently be transferred to the substance 204 being transported in the pipe 202. In the present embodiments, the flexible sheath 210 is curved/bent around portions of the body of the pipe 202 (as shown in FIG. 2A) and is curved/bent around an end area of the pipe 202 (as shown in FIG. 2B).

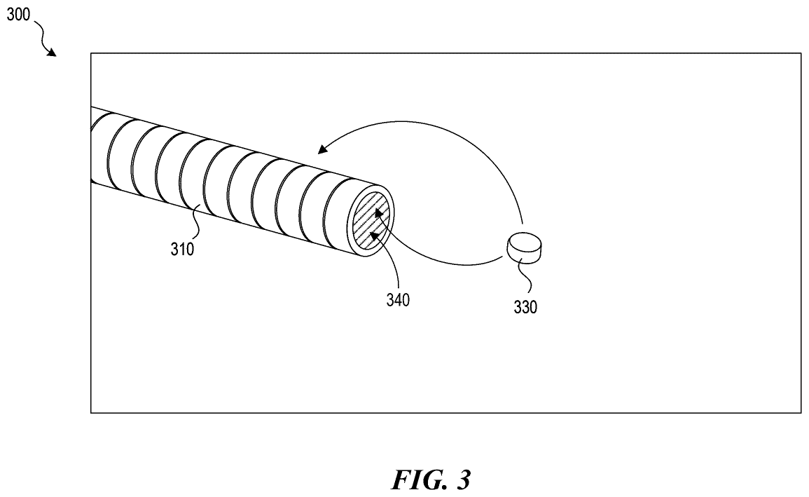

FIG. 3 is a perspective view of an apparatus 300 configured in accordance with some embodiments of the present technology. In the present embodiments, the heating apparatus 300 includes a flexible sheath 310 forming a lumen 340. In some embodiments, the lumen 340 extends approximately the entire length of the flexible sheath 310. In some embodiments, the lumen 340 is formed in particular segments or portions of the sheath 310. That is, in some embodiments, multiple lumens 340 can be formed, where one or more of the lumens 340 are separated by filled-in portions of the flexible sheath 310. The flexible sheath 310 is configured to hold one or more heat sources (not shown, described with reference to FIGS. 1A-2B), and one or more magnetic elements 330 (one of which is shown outside of the flexible sheath 310 in FIG. 3). The magnetic elements 330 can be a variety of sizes, shapes, lengths, and other dimensions, as appropriate to both fit within the sheath 310 and provide sufficient magnetic force on ferrous surfaces (e.g., of a pipe) outside of the sheath 310. For example, one or more of the magnetic elements 330 can be a puck-shape, as shown in FIG. 3.

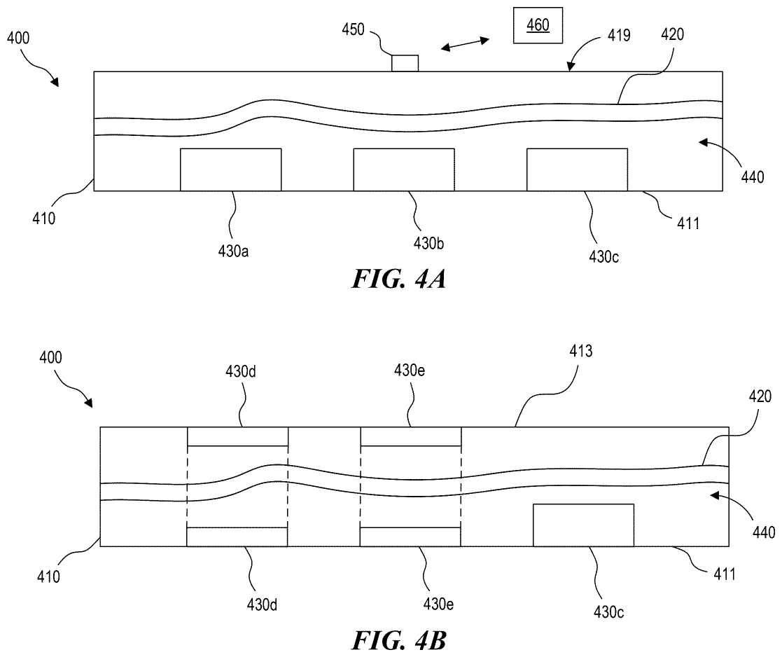

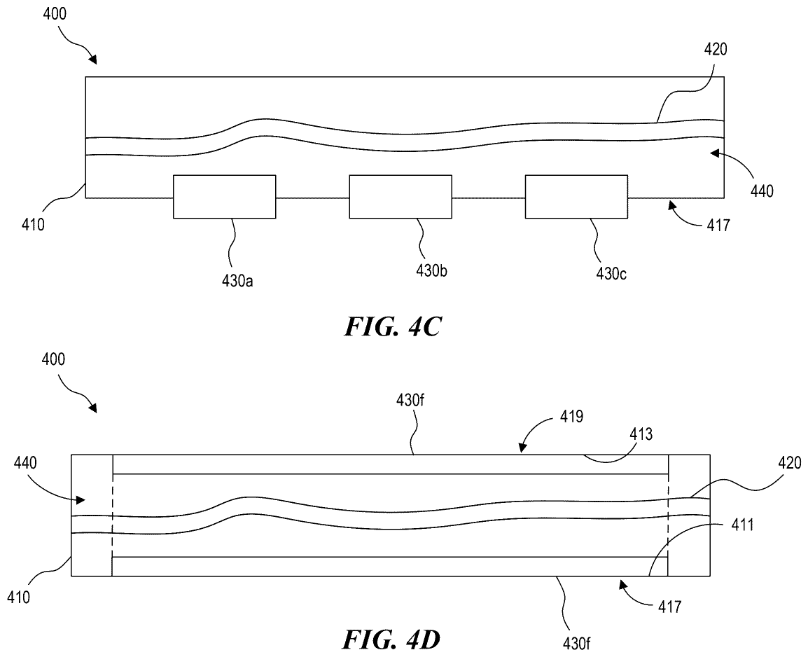

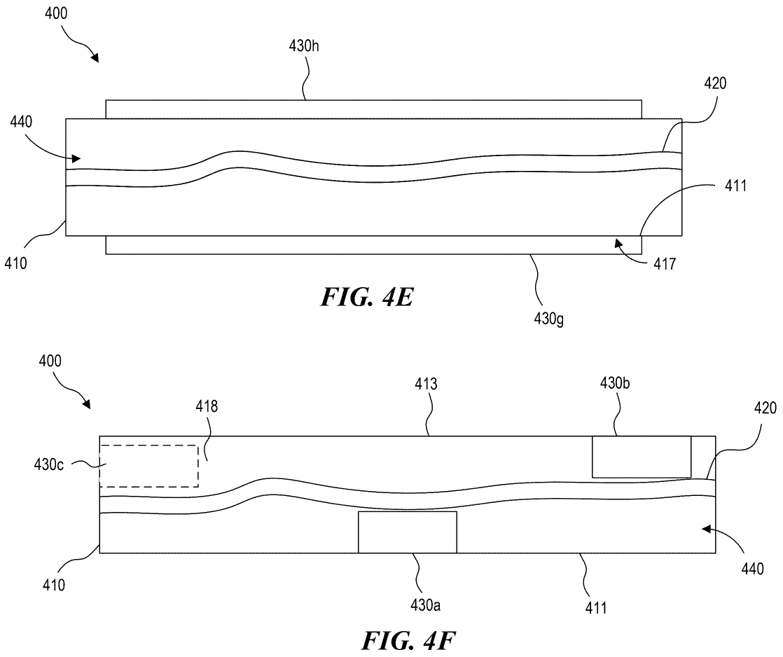

FIGS. 4A-4F are various schematic cross-sectional views of an apparatus 400 configured in accordance with some embodiments of the present technology. In some embodiments, the apparatus 400 includes one or more features and/or components generally similar/identical to the features and components of the apparatus 100 of FIGS. 1A-1B, the system 200 of FIGS. 2A-2B, and/or the apparatus 300 of FIG. 3.

In the embodiments shown in FIG. 4A, heating apparatus 400 is comprised of a flexible sheath 410 containing one or more heat sources 420 (e.g., electric heating elements). The flexible sheath 410 forms a lumen 440 configured to hold the one or more heat sources 420. In the present embodiments, the flexible sheath 410 is further comprised of one or more magnetic elements 430 (represented as three individual magnetic elements 430a, 430b, and 430c) in contact with an inner surface 411 of the sheath 410. The magnetic elements 430a-c are contained within the lumen 440 of the sheath 410. In some embodiments, each of the magnetic elements 430a-c is the same type (i.e., the same shape, material, etc.). In some embodiments, one or more of the magnetic elements 430a-c can be a different type from the others. In some embodiments, one or more of the magnetic elements 430a-c is coupled to the inner surface 411 of the sheath 410 via glue and/or epoxy. In some embodiments the magnetic elements 430a-c are coupled to the inner surface 411 of the sheath 410 via welding material (i.e., the magnetic elements 430a-c are welded to the inner surface 411). By positioning the magnetic elements 430a-c within the lumen 440 of the sheath 410, cumbersome/unwieldy coupling elements, such as wiring, tape, cabling, and/or strapping can be used much less or even avoided altogether.

In some embodiments, heating apparatus 400 includes one or more temperature sensing elements 450 (e.g., thermistors, resistance temperature detectors (RTDs), thermocouples, thermowells, and the like) configured to obtain a temperature of the flexible sheath 410 and/or heat source 420. In some embodiments, as shown in FIG. 4A, one or more of the temperature sensing elements 450 are positioned and/or coupled on an outer surface 419 of the flexible sheath 410. In some embodiments, one or more of the temperature sensing elements 450 are positioned and/or coupled on an inner surface (e.g., inner surface 411) of the flexible sheath 410. In some embodiments, one or more of the temperature sensing elements 450 are positioned and/or coupled to the heat source 420 (e.g., where the heat source 420 is an electric heating element). In some embodiments, the temperature corresponds to the heat transferred from the heat source 420 to the flexible sheath 410, and/or to a pipe/piping system coupled to the flexible sheath 410.

In some embodiments, the temperature sensing elements 450 are configured to provide temperature signals to a controller 460. The controller 460 is configured to control (e.g., modify, increase, decrease, maintain, etc.) the heat transferred from the heat source 420 to the flexible sheath 410 and/or to a pipe/piping system coupled to the flexible sheath 410. For example, the controller 460 can be configured to reduce the heat generated by an electric heating element 420 of the heating apparatus 400 by reducing the current passing through the heating element 420 in response to a temperature signal that meets or exceeds a threshold temperature.

In the embodiments shown in FIG. 4B, heating apparatus 400 is generally similar to the embodiments shown in FIG. 4A. One of the principle differences between the embodiments of FIG. 4A and FIG. 4B is that the flexible sheath 410 is comprised of two different types of magnetic elements 430c, 430d, 430e. For example, magnetic elements 430d and 430e can be flexible and/or ring-shaped magnetic elements that extend around the inner circumference of the flexible sheath 410. As shown in FIG. 4B, magnetic elements 430d and 430e are coupled to the flexible sheath 410 such that a surface of each of the magnetic elements 430d and 430e is in contact with a first inner surface 411 of the sheath 410 and a second inner surface 413 of the sheath 410, where the second inner surface 413 is opposite the first inner surface 411. Magnetic element 430c is a different type of magnetic element than magnetic elements 430d and 430e. For example, magnetic element 430c can be a puck-shaped magnet coupled to the first inner surface 411. By including a variety of different types of magnetic elements, the apparatus 400 can be readily adapted and/or customized to accommodate a wide variety of pipes, piping systems, piping arrangements, and/or piping system components (e.g., valves).

In the embodiments shown in FIG. 4C, heating apparatus 400 is generally similar to the embodiments shown in FIG. 4A. One of the principle differences between the embodiments of FIG. 4A and FIG. 4C is that the magnetic elements 430a-c are embedded in (e.g., integrated with) an outer surface 417 of the sheath 410 such that one or more of the magnetic elements 430a-c has a surface facing outward from the flexible sheath 410. By embedding the magnetic elements 430a-c in the outer surface 417 of the sheath 410, one or more of the magnetic elements 430a-c can come into contact with a magnetic (e.g., ferrous) surface of a pipe, which result in a greater magnetic force, and thus greater adherence/coupling of the apparatus 400 to the pipe.

In the embodiments shown in FIG. 4D, heating apparatus 400 is generally similar to the embodiments shown in FIG. 4A. One of the principle differences between the embodiments of FIG. 4A and FIG. 4D is that the flexible sheath 410 includes a single continuous magnetic element 430f that runs approximately the length of the flexible sheath 410. In some embodiments, the magnetic element 430f is a magnetic liner that couples to one or more points of the circumference of the inner surface 411 of the sheath 410.

In the embodiments shown in FIG. 4E, heating apparatus 400 is generally similar to the embodiments shown in FIG. 4D. One of the principle differences between the embodiments of FIG. 4D and FIG. 4E is that the flexible sheath 410 includes a first magnetic element 430g positioned on a first outer surface 417 of the flexible sheath 410, and a second magnetic element 430h positioned on a second outer surface 419 of the flexible sheath 410, where the first outer surface 417 is opposite the second outer surface 419. Each of the magnetic elements 430g, 430h is configured as a continuous strip and/or liner type of magnet that includes a surface configured to contact a pipe (e.g., a ferrous surface of a pipe).

In the embodiments shown in FIG. 4F, heating apparatus 400 is generally similar to the embodiments shown in FIG. 4A. One of the principle differences between the embodiments of FIG. 4A and FIG. 4F is that the flexible sheath includes a first magnetic element 430a positioned on a first inner surface 411, a second magnetic element 430b positioned on a second inner surface 413, and a third magnetic element 430c positioned on a third inner surface 418.

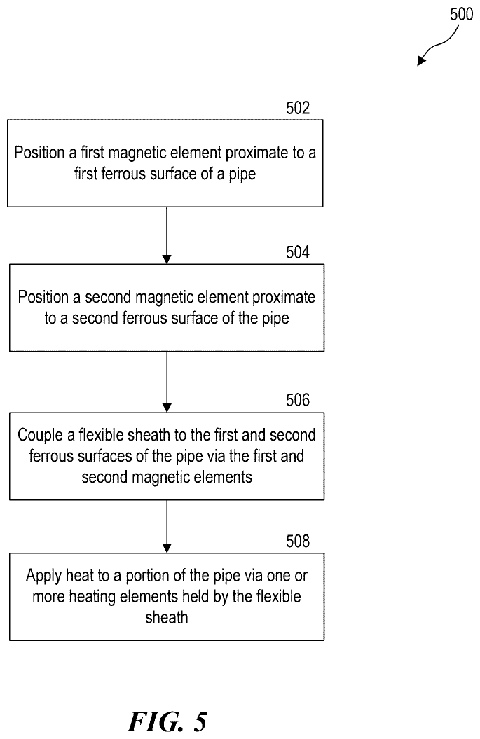

FIG. 5 is a flow chart illustrating a method 500 in accordance with some embodiments of the present technology. In some embodiments, method 500 is implemented using apparatuses and/or systems described with reference to FIGS. 1A-4F.

At block 502, a first magnetic element is positioned proximate to a first ferrous surface of a pipe. In some embodiments, the first magnetic element is coupled and/or positioned within a flexible sheath, and positioning the first magnetic element includes moving and/or positioning a portion of the flexible sheath containing the first magnetic element. In some embodiments, the first magnetic element is coupled and/or positioned on an external surface of the flexible sheath. In some embodiments, the first magnetic element is embedded in the wall of the flexible sheath such that a first surface of the first magnetic element is facing outward from the flexible sheath (e.g., towards the first ferrous surface of the pipe). At block 504, a second magnetic element is positioned proximate to a second ferrous surface of a pipe.

At block 506, a flexible sheath is coupled to the first and second ferrous surfaces of the pipe via the first and second magnetic elements. For example, a magnetic force exhibited by the first and second magnetic elements can couple the sheath to the pipe. At block 508, heat is applied to the portion of the pipe to which the flexible sheath is coupled. The heat is applied via one or more heat sources held by (e.g., contained at least partially within) the flexible sheath.

In some embodiments, the flexible sheath includes one or more temperature sensing elements configured to provide temperature feedback signals to a controller. The controller can be configured to change/adjust/modify the heat applied by modifying the temperature of the heat source, and/or modifying the heat generated by the heat source. In such embodiments, the method 500 can further include: providing a temperature signal corresponding to the heat applied to the portion of the pipe, and modifying the heat applied by the one or more heat sources based on the temperature signal.

### Conclusion

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following examples should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the examples.

To reduce the number of examples, certain aspects of the technology are presented below in certain example forms, but the applicant contemplates the various aspects of the technology in any number of example forms. For example, while only one aspect of the technology is recited as a computer-readable medium example, other aspects may likewise be embodied as a computer-readable medium example, or in other forms, such as being embodied in a means-plus-function example. Any examples intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional examples after filing this application to pursue such additional example forms, in either this application or in a continuing application.

The present technology is illustrated, for example, according to various aspects described below as numbered clauses, examples, or embodiments (1, 2, 3, etc.) for convenience. These are provided as examples and do not limit the present technology. It is noted that any of the dependent clauses can be combined in any combination, and placed into a respective independent clause.

1. a Heating System Comprising:
a pipe; and
a flexible sheath including:
   one or more heat sources contained within at least a portion of the flexible sheath; and
   one or more magnetic elements coupled to a surface of the flexible sheath, wherein the one or more magnetic elements are configured to couple the flexible sheath to a portion of the pipe;
wherein the one or more heat sources are configured to increase a temperature of the portion of the pipe.

2. The system of any of the examples herein, wherein at least one of the one or more magnetic elements is coupled to an inner surface of the flexible sheath.

3. The system of any of the examples herein, wherein at least one of the one or more magnetic elements is embedded in the surface of the flexible sheath such that an outer surface of the at least one magnetic element is configured to contact the pipe.

4. The system of any of the examples herein, wherein at least one of the one or more magnetic elements is welded to the flexible sheath.

5. The system of any of the examples herein, wherein at least one of the one or more magnetic elements is coupled to the flexible sheath via glue and/or epoxy.

6. The system of any of the examples herein, wherein at least one of the one or more magnetic elements is formed of a flexible magnetic material, and wherein the at least one magnetic element is coupled to the surface of the flexible sheath such that the magnetic element follows a contour of the flexible sheath.

7. The system of any of the examples herein, wherein at least one of the one or more magnetic elements is coupled to an outer surface of the flexible sheath.

8. The system of any of the examples herein, wherein the flexible sheath is formed from a plurality of interlocking metal segments.

9. The system of any of the examples herein, wherein the flexible sheath includes a first surface and a second surface, and the one or more magnetic elements include a first magnetic element and a second magnetic element, wherein the first magnetic element is coupled to the first surface and the second magnetic element is coupled to the second surface.

10. The system any of the examples herein, wherein the flexible sheath includes a first surface, a second surface, and a third surface, and the one or more magnetic elements includes a first magnetic element, a second magnetic element, and a third magnetic element, wherein the first magnetic element is coupled to the first surface, the second magnetic element is coupled to the second surface, and the third magnetic element is coupled to the third surface.

11. A heating apparatus comprising:
a flexible hollow cylinder;
one or more electric heating elements within a portion of the flexible hollow cylinder; and
one or more magnetic elements coupled to the flexible hollow cylinder;
wherein the flexible hollow cylinder is configured to couple to a ferrous surface of a pipe via a magnetic force of the one or more magnetic elements.

12. The apparatus of any of the examples herein, wherein at least one of the one or more magnetic elements is coupled to an inner surface of the flexible hollow cylinder.

13. The apparatus of any of the examples herein, wherein at least one of the one or more magnetic elements is embedded in a surface of the flexible hollow cylinder such that an outer surface of the at least one magnetic element is positioned outside of the hollow cylinder.

14. The apparatus of any of the examples herein, wherein at least one of the one or more magnetic elements is welded to the flexible hollow cylinder.

15. The apparatus of any of the examples herein, wherein at least one of the one or more magnetic elements is coupled to the flexible hollow cylinder via glue and/or epoxy.

16. The apparatus of any of the examples herein, wherein at least one of the one or more magnetic elements is formed of a flexible magnetic material, and wherein the at least one magnetic element is coupled to a surface of the flexible hollow cylinder such that the magnetic element follows a contour of the flexible hollow cylinder.

17. The apparatus of any of the examples herein, wherein at least one of the one or more magnetic elements is coupled to an outer surface of the flexible magnetic cylinder.

18. The apparatus of any of the examples herein, wherein the flexible hollow cylinder is formed from a plurality of interlocking metal segments.

19. A method of heating a portion of a pipe, the method comprising:
coupling a flexible sheath to the portion of the pipe via one or more magnetic elements, the flexible sheath holding one or more heat sources; and
applying heat to the portion of the pipe via the one or more heat sources.

20. The method of any of the examples herein, further comprising:
positioning a first magnetic element proximate to a first ferrous surface of the pipe; and
positioning a second magnetic element proximate to a second ferrous surface of the pipe.

I/We claim:

1. A heating system comprising:
a pipe; and
a flexible sheath including:
one or more heat sources contained within at least a portion of the flexible sheath; and
one or more magnetic elements coupled to a surface of the flexible sheath, wherein the one or more magnetic elements are configured to couple the flexible sheath to a portion of the pipe;
wherein the one or more heat sources are configured to increase a temperature of the portion of the pipe.

2. The system of claim 1 wherein at least one of the one or more magnetic elements is coupled to an inner surface of the flexible sheath.

3. The system of claim 1 wherein at least one of the one or more magnetic elements is embedded in the surface of the flexible sheath such that an outer surface of the at least one magnetic element is configured to contact the pipe.

4. The system of claim 1 wherein at least one of the one or more magnetic elements is welded to the flexible sheath.

5. The system of claim 1 wherein at least one of the one or more magnetic elements is coupled to the flexible sheath via glue and/or epoxy.

6. The system of claim 1 wherein at least one of the one or more magnetic elements is formed of a flexible magnetic material, and wherein the at least one magnetic element is coupled to the surface of the flexible sheath such that the magnetic element follows a contour of the flexible sheath.

7. The system of claim 1 wherein at least one of the one or more magnetic elements is coupled to an outer surface of the flexible sheath.

8. The system of claim 1 wherein the flexible sheath is formed from a plurality of interlocking metal segments.

9. The system of claim 1 wherein the flexible sheath includes a first surface and a second surface, and the one or more magnetic elements include a first magnetic element and a second magnetic element, wherein the first magnetic element is coupled to the first surface and the second magnetic element is coupled to the second surface.

10. The system of claim 9 wherein the flexible sheath includes a third surface and the one or more magnetic elements includes a third magnetic element, wherein the third magnetic element is coupled to the third surface.

11. A heating apparatus comprising:
a flexible hollow cylinder;
one or more electric heating elements within a portion of the flexible hollow cylinder; and
one or more magnetic elements coupled to the flexible hollow cylinder;
wherein the flexible hollow cylinder is configured to couple to a ferrous surface of a pipe via a magnetic force of the one or more magnetic elements.

12. The apparatus of claim 11 wherein at least one of the one or more magnetic elements is coupled to an inner surface of the flexible hollow cylinder.

13. The apparatus of claim 11 wherein at least one of the one or more magnetic elements is embedded in a surface of the flexible hollow cylinder such that an outer surface of the at least one magnetic element is positioned outside of the hollow cylinder.

14. The apparatus of claim 11 wherein at least one of the one or more magnetic elements is welded to the flexible hollow cylinder.

15. The apparatus of claim 11 wherein at least one of the one or more magnetic elements is coupled to the flexible hollow cylinder via glue and/or epoxy.

16. The apparatus of claim 11 wherein at least one of the one or more magnetic elements is formed of a flexible magnetic material, and wherein the at least one magnetic element is coupled to a surface of the flexible hollow cylinder such that the magnetic element follows a contour of the flexible hollow cylinder.

17. The apparatus of claim 11 wherein at least one of the one or more magnetic elements is coupled to an outer surface of the flexible magnetic cylinder.

18. The apparatus of claim 11 wherein the flexible hollow cylinder is formed from a plurality of interlocking metal segments.

19. A method of heating a portion of a pipe, the method comprising:
coupling a flexible sheath to the portion of the pipe via one or more magnetic elements, the flexible sheath holding one or more heat sources; and
applying heat to the portion of the pipe via the one or more heat sources.

20. The method of claim 19, further comprising:
positioning a first magnetic element proximate to a first ferrous surface of the pipe; and
positioning a second magnetic element proximate to a second ferrous surface of the pipe.
